(19) United States
(12) Patent Application Publication
(10) Pub. No.: US 2026/0366495 A1
(43) Pub. Date: Nov. 19, 2026

(54) Forced Cooling Apparatus

(71) Applicant: Zephyr Wind Services MN, LLC, Centennial, CO (US)

(72) Inventors: Nick Gabrielson, Litchfield, MN (US); Joshua Jackson, Russell, MN (US)

(21) Appl. No.: 19/679,699

(22) Filed: May 17, 2026

Related U.S. Application Data
(60) Provisional application No. 63/807,214, filed on May 16, 2025.

(51) Int. Cl. F03D 80/60

(52) U.S. Cl. CPC F03D 80/60; F05B 2260/232

(57) ABSTRACT

An aftermarket forced cooling apparatus for a wind turbine generator that was not originally designed with an external fan assembly. The forced cooling apparatus is attached to the generator without modifications to the generator and enhances the removing of heat from the generator.

### CROSS REFERENCE TO RELATED APPLICATION

This application claims the benefit of U.S. Provisional Application Ser. No. 63/807,214 filed on May 16, 2025, and titled “GE 2.X GENERATOR FORCED COOLING APPARATUS” which is incorporated herein by reference in its entirety for all that is taught and disclosed therein.

### BACKGROUND OF THE INVENTION

The invention relates to the cooling airflow for generators manufactured by Indar, GE, and Winergy used in the GE 2.X wind turbine platform. During operation, generator temperature detectors trigger alarms and halt energy production during overtemperature events. Currently, no solution has been marketed to adequately address overheating while meeting end users' desire to maintain the turbine in a power-generating state.

### SUMMARY OF THE INVENTION

The forced cooling apparatus comprises an adapter plate, electric motor, fan, and electrical components that interface with the turbine's control system. When activated by the turbine's control system at a predetermined temperature setpoint, the forced cooling apparatus increases airflow, reducing generator operating temperatures and minimizing downtime caused by overheating.

### BRIEF DESCRIPTION OF THE SEVERAL VIEWS OF THE DRAWINGS

FIG. 1A shows all the disassembled parts of a forced cooling apparatus in an embodiment of the present disclosure.

FIG. 1B shows a partial assembly of a forced cooling apparatus without the fan or motor in an embodiment of the present disclosure.

FIG. 2 shows a forced cooling apparatus installed on a generator in a wind turbine in an embodiment of the present disclosure.

FIG. 3 shows a graph of internal temperatures of four wind turbine generators all operating close to each according to their design specifications.

FIG. 4 shows a graph of internal temperatures of four wind turbine generators all operating close to each other with a forced cooling apparatus installed on one of the wind turbine generators in an embodiment of the present disclosure.

FIG. 5 shows a typical wind turbine infrastructure in the prior art.

FIG. 6 shows the fan shroud adapter hoisted up the wind turbine tower into the nacelle in an embodiment of the present disclosure.

FIG. 7 shows the electric winch used to raise the component parts of the forced cooling apparatus in an embodiment of the present disclosure.

FIG. 8 shows the cooler inlet of the wind turbine generator with its cover removed in an embodiment of the present disclosure.

FIG. 9 shows the fan shroud adapter connected to the cooler inlet in an embodiment of the present disclosure.

FIG. 10 shows the second fan shroud with its shelf connected to the fan shroud adapter in an embodiment of the present disclosure.

FIG. 11 shows the fan motor and fan blades connected to the shelf in an embodiment of the present disclosure.

FIG. 12 shows the first fan shroud connected to the second fan shroud and the fan shroud adapter in an embodiment of the present disclosure.

FIG. 13 shows the filter housing connected to the second fan shroud and the first fan shroud in an embodiment of the present disclosure.

FIG. 14 shows the electrical cabinet located in the nacelle and the electrical connections required in an embodiment of the present disclosure.

To assist in the understanding of the present disclosure the following list of components and associated numbering found in the drawings is provided herein:

Table of Components.

| Component | # |
|---|---|
| fan shroud adapter | 1 |
| first fan shroud | 2 |
| second fan shroud | 3 |
| shelf | 3B |
| filter housing | 4 |
| fan motor | 5 |
| fan blades | 6 |
| prefilter | 7 |
| magnetic prefilter | 8 |
| hardware kit | 9 |
| wind turbine generator | 10 |
| rigging | 12 |
| work platform | 14 |
| nacelle | 16 |
| winch | 18 |
| cooler inlet | 20 |
| wire | 22 |
| opening | 24 |
| electrical cabinet | 26 |
| unused breaker | 28 |
| new contractor | 30 |
| terminal block | 32 |
| terminal strip | 34 |
| gear box oil pumping | 36 |
| high speed contactor | |
| forced cooling apparatus | 100 |

### DETAILED DESCRIPTION

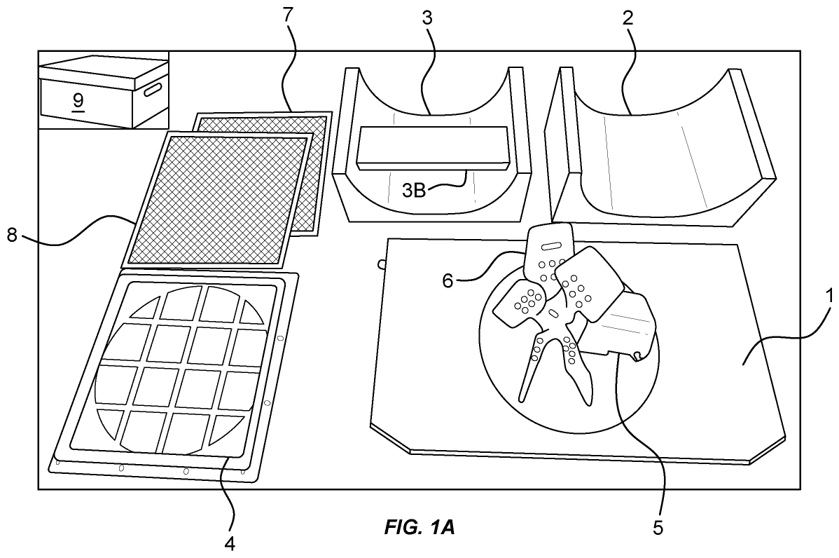

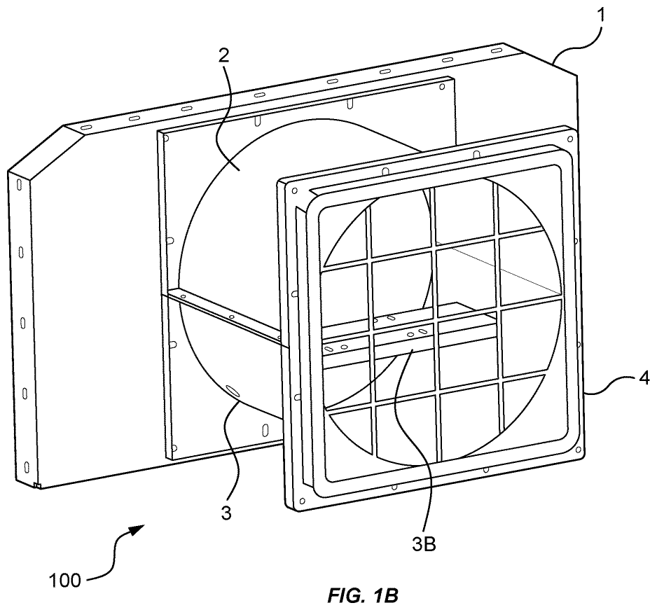

Referring now to the Figures, in which like reference numerals refer to structurally and/or functionally similar elements thereof, FIG. 1A shows all the disassembled parts of a forced cooling apparatus in an embodiment of the present disclosure. Referring now to FIG. 1A, fan shroud adapter 1 is the interface between the generator and the forced cooling apparatus 100. First fan shroud 2 and second fan shroud 3 mate together and form the circumferential fan shroud. Second fan shroud 3 has a shelf 3B to which the fan motor 5 is mounted to. Fan blades 6 are attached to the fan motor 5. Filter housing 4 houses Slide-in prefilter 7 is designed to filter incoming cooling air. It is important to filter the air before entering the generator because this air is blown directly through the internal components versus a traditional generator cooler that uses radiant heat cooler to remove heat without introducing fresh outside air to internal components. Magnetic pre filter 8 is designed to further filter air and provide an easy to clean filter. This pre filter should be cleaned on a quarterly basis but possibly more depending on environmental conditions i.e.: dust, farming, other airborne particles. Hardware kit 9 contains necessary hardware to connect the structure together and connect the structure to the generator cooler housing. In one embodiment hardware kit 9 contains the following hardware items: M8-1.25×20 mm bolts with washer and lock washer hold fan shroud adapter 1 to the generator cooler. M8-1.25×20 mm bolts with washer and lock washer hold first fan shroud 2 and second fan shroud 3 to fan shroud adapter 1. M10-1.5×45 mm with washers and nyloc nut hold fan motor 5 to second fan shroud 3. M8-1.25 carriage bolts attach first fan shroud 2 and second fan shroud 3 together. M8-1.25×25 mm bolts, washers, and nuts hold filter housing 4 to first fan shroud 2 and second fan shroud 3.

FIG. 1B shows a partial assembly of a forced cooling apparatus in an embodiment of the present disclosure. Referring now to FIG. 1B, first fan shroud 2 and second fan shroud 3 are attached together to each other and attached on at a first end to fan shroud adapter 1 and attached at a second end to filter housing 4. Not shown are the fan blades 6, fan motor 5, prefilter 7, magnetic prefilter 8, and hardware kit 9.

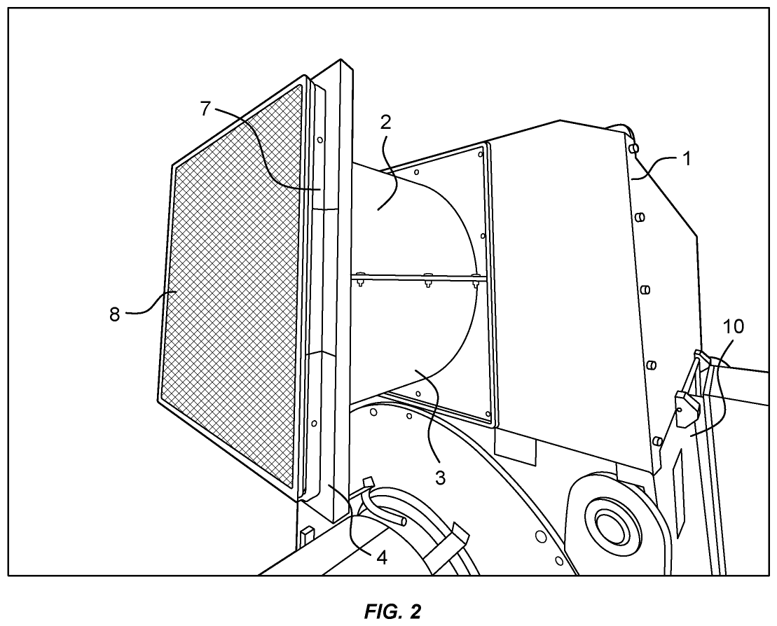

FIG. 2 shows a forced cooling apparatus installed on a generator in a wind turbine in an embodiment of the present disclosure. Referring now to FIG. 2, fan shroud adapter 1 is connected to the wind turbine generator. This connection is typically accomplished through bolting but one skilled in the art will recognize that other suitable connection items and methods may be used, such as welding, screwing, wiring, soldering, clamping, etc. The term “connected’ or “connection” or “connecting” as used in this disclosure encompasses any suitable connection method to connect a first part to a second part. First fan shroud 2 and second fan shroud 3 are connected together forming a circular structure. A first end of the first fan shroud 2 and second fan shroud 3 and are connected to the fan shroud adapter 1. A second end of the first fan shroud 2 and second fan shroud 3 is connected to a filter housing 4. A shelf 3B is connected to an inner portion of the second fan shroud 3. A fan motor 5 is connected to the shelf 3B and a fan blades 6 is connected to the fan motor 5 such that the fan motor 5 and fan blades 6 are contained within the circular structure formed by the first fan shroud 2 and second fan shroud 3. Prefilter 7 is inserted first into the filter housing 4 and magnetic prefilter 8 is inserted next into the filter housing 4 thereafter such that air drawn by the operation of the fan motor 5 and fan blades 6 travels first through magnetic pre filter 8 and then through prefilter 7. The hardware kit 9 described above contains all of the necessary hardware to make all of the connections described above.

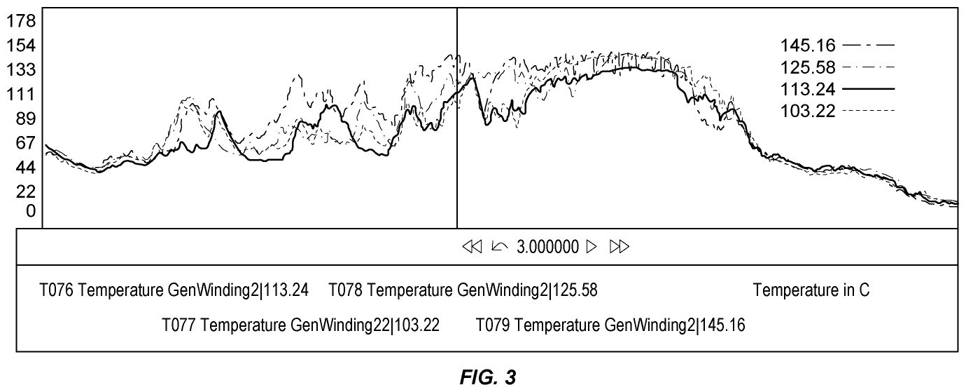

FIG. 3 shows a graph of internal temperatures of four wind turbine generators all operating close to each according to their design specifications. Referring now to FIG. 3, the Y axis shows internal temperature in Celsius and the X axis shows time over a three day period. The data shows four different turbines all running very close to each other. The data temperature and time data was captured from factory installed internal winding sensors on the wind turbine generators and the wind turbine software compiles the data into the graph shown. The temperatures are internal wind turbine generator temperatures while the wind turbines are running. The blue line represents a first wind turbine generator designated T076 with a peak temperature of 113.24 C. The orange line represents a second wind turbine generator designated T077 with a peak temperature of 103.22 C. The grey line represents a third wind turbine generator designated T078 with a peak temperature of 125.58 C. The yellow line represents a fourth wind turbine generator designated T079 with a peak temperature of 145.16 C.

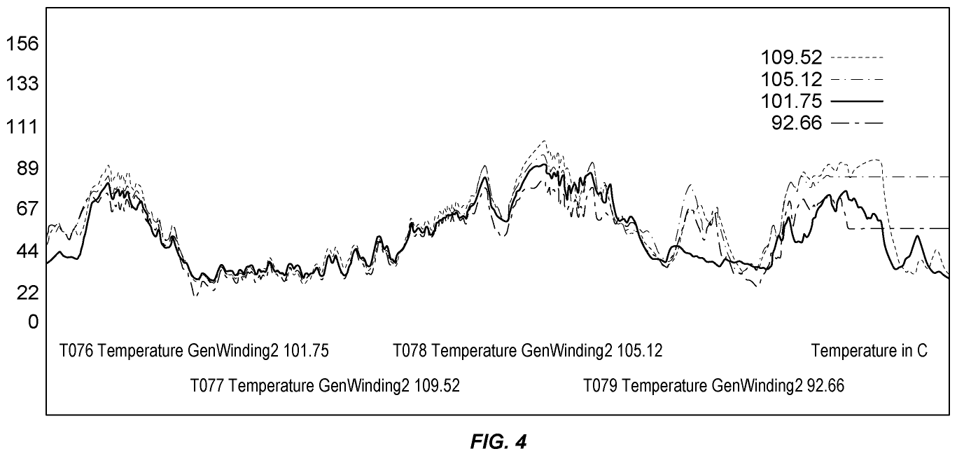

FIG. 4 shows a graph of internal temperatures of four wind turbine generators all operating close to each other with a forced cooling apparatus installed on one of the wind turbine generators in an embodiment of the present disclosure. Referring now to FIG. 4, the Y axis shows temperature in Celsius and the X axis shows time over a three day period after a forced cooling apparatus was installed a few days later on the wind turbine generator designated as T079. The blue line represents the first wind turbine generator designated T076 with a peak temperature of 101.75 C. The orange line represents the second wind turbine generator designated T077 with a peak temperature of 109.52 C. The grey line represents the third wind turbine generator designated T078 with a peak temperature of 105.12 C. The yellow line represents the fourth wind turbine generator designated T079 with a peak temperature of 92.66 C. As the two graphs show, the internal peak temperatures of the three wind turbine generators vary from day to day within a small relative peak temperature range between around 6 °C to 20 °C compared to the drastic change in relative peak temperature range of 53 °C for the T079 wind turbine generator after the forced cooling apparatus was installed. The forced cooling apparatus thus reduces the wind generator internal operating temperatures and results in minimizing downtime caused by overheating.

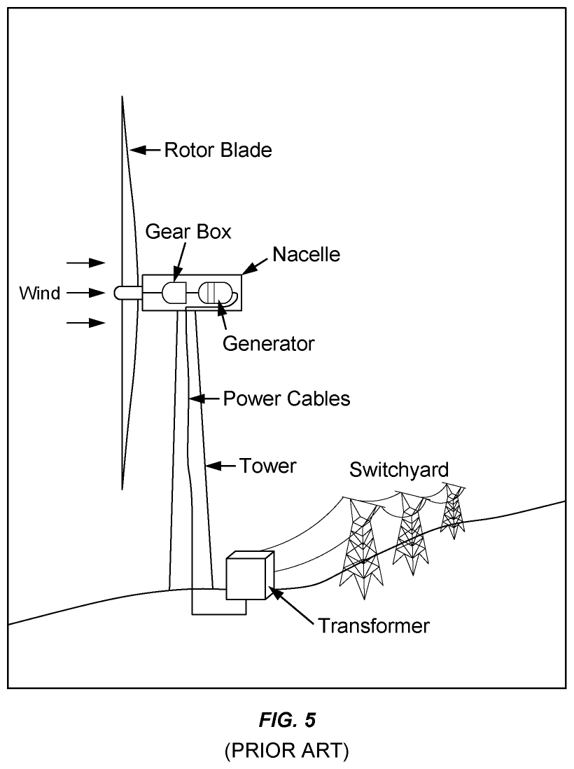

FIG. 5 shows a typical wind turbine infrastructure in the prior art. Referring now to FIG. 5, Rotor blades external to the nacelle catch the wind and transfer the kinetic energy through the gear box to the wind turbine generator. Electricity from the wind turbine generator is delivered through the power cables in the tower to a transformer on the ground and on to a switchyard.

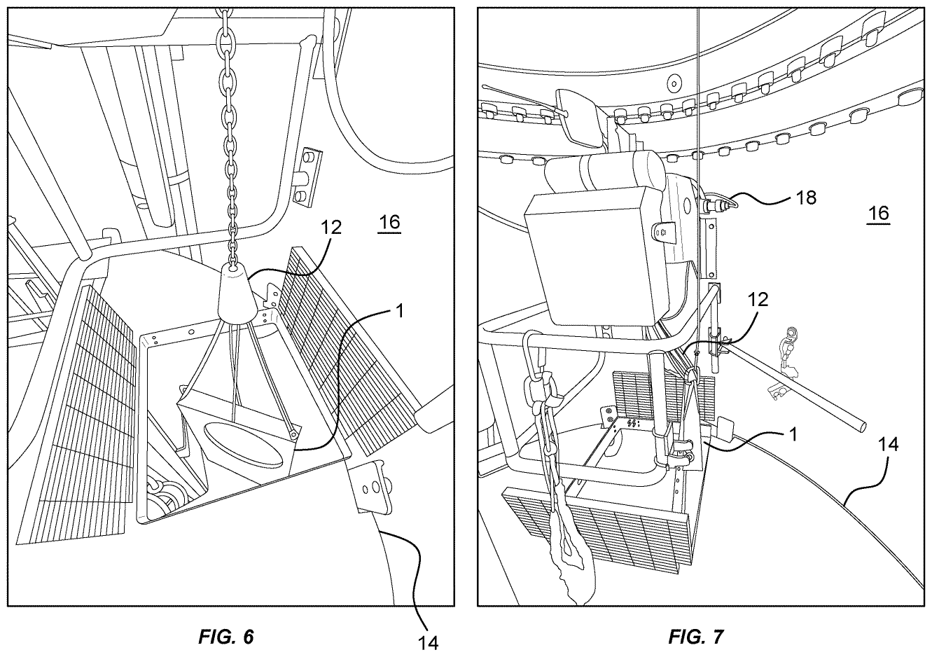

FIGS. 6-14 show the method of installing the forced cooling apparatus onto a wind turbine generator for cooling the airflow into the wind turbine generator.

FIG. 6 shows the fan shroud adapter hoisted up the wind turbine tower into the nacelle in an embodiment of the present disclosure. Referring now to FIG. 6, rigging 12 is used to attach to the various components of the forced cooling apparatus and hoist them up to the work platform 14 in the nacelle 16. Shown in FIG. 6 is the fan shroud adapter 1 hoisted to the nacelle 16.

FIG. 7 shows the electric winch used to raise the component parts of the forced cooling apparatus in an embodiment of the present disclosure. Referring now to FIG. 7, fan shroud adapter 1 has been hoisted into the nacelle 16 by the winch 18. All the rest of the components of the forced cooling apparatus 100 are hoisted up to the nacelle 16 as described in FIGS. 6 and 7.

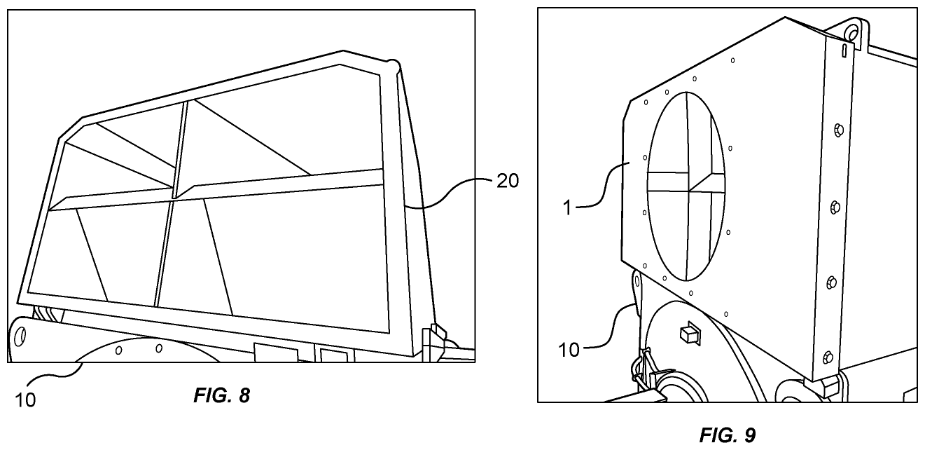

FIG. 8 shows the cooler inlet of the wind turbine generator with its cover removed in an embodiment of the present disclosure. Referring now to FIG. 8, a cover (not shown) has been removed from the cooler inlet 20 of the wind turbine generator 10.

FIG. 9 shows the fan shroud adapter connected to the cooler inlet in an embodiment of the present disclosure. Referring now to FIG. 9, fan shroud adapter 1 is connected to the cooler inlet 20.

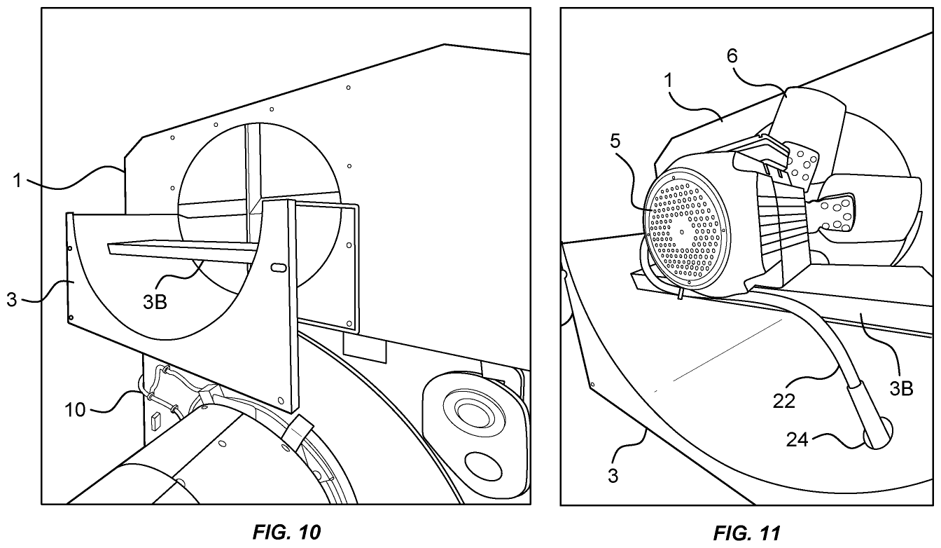

FIG. 10 shows the second fan shroud with its shelf connected to the fan shroud adapter in an embodiment of the present disclosure. Referring now to FIG. 10, shelf 3B is connected to second fan shroud 3. Second fan shroud 3 is then connected to the fan shroud adapter 1.

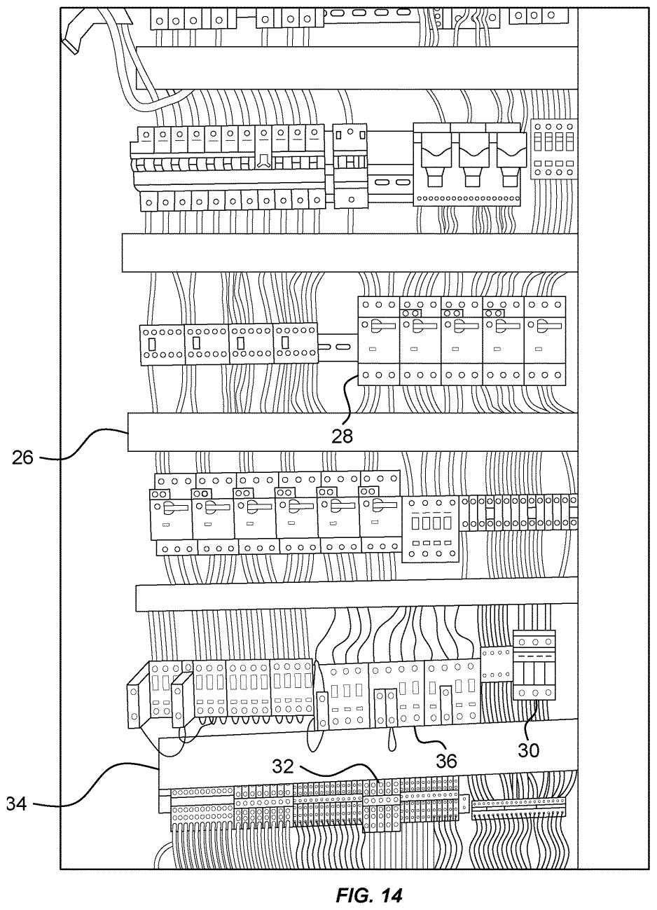

FIG. 11 shows the fan motor and fan blades connected to the shelf in an embodiment of the present disclosure. Referring now to FIG. 11, fan blades 6 are connected to the fan motor 5 and the fan motor 5 is connected to the shelf 3B and centered on shelf 3b so that the tips of the fan blades 6 do not contact the inner sides of second fan shroud 3. Fan blades 6 and fan motor 5 are referred to collectively as the fan assembly. Wire 22 is connected to the fan motor 5 and then run through opening 24 in the second fan shroud 3 and run down the front of the wind turbine generator 10 and to the top of the electrical cabinet 26 (see FIG. 14).

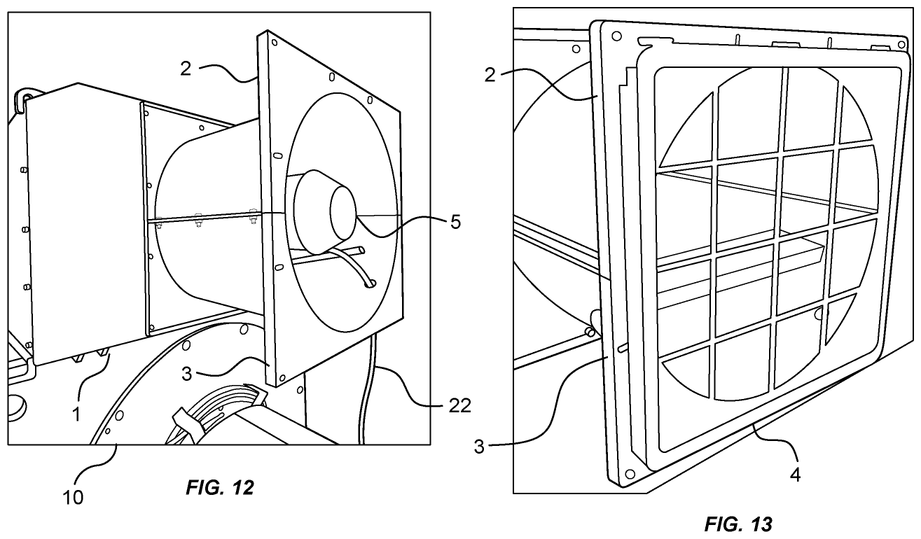

FIG. 12 shows the first fan shroud connected to the second fan shroud and the fan shroud adapter in an embodiment of the present disclosure. Referring now to FIG. 12, first fan shroud 2 is connected to second fan shroud 3 and to fan shroud adapter 1.

FIG. 13 shows the filter housing connected to the second fan shroud and the first fan shroud in an embodiment of the present disclosure. Referring now to FIG. 13, filter housing 4 is connected to first fan shroud 2 and is connected to second fan shroud 3. As described above and shown in FIG. 2, prefilter 7 and magnetic prefilter 8 are inserted into filter housing 4.

FIG. 14 shows the electrical cabinet located in the nacelle and the electrical connections required in an embodiment of the present disclosure. Referring now to FIG. 14, wire 22 is run to the top of the electrical cabinet 26. Existing unused breaker 28 is located. Verify that unused breaker 28 is already wired to terminal strip 34. New contractor 30 is installed in the electrical cabinet 26. Locate and cut wires from unused breaker 28 and route them into the new contractor 30. Wire 22 is connected to the terminal block 32. Connect the new contractor 30 in parallel with the existing gear box oil pumping high speed contactor 36 24 VDC signal wire. After these electrical connections are made, when the gear oil pump is commanded on, the fan motor 5 of the forced cooling apparatus 100 will be commanded on automatically by a signal.

Having described the present invention, it will be understood by those skilled in the art that many changes in construction and circuitry and widely differing embodiments and applications of the invention will suggest themselves without departing from the scope of the present invention.

What is claimed is:

1. A method for cooling airflow into a wind turbine generator, the method comprising the steps of:
(a) connecting a fan shroud adapter to a cooler inlet of the wind turbine generator;
(b) connecting a shelf to a second fan shroud;
(c) connecting a fan assembly to the shelf;
(d) connecting the second fan shroud to the fan shroud adapter;
(e) connecting a first fan shroud to the second fan shroud and to the fan shroud adapter;
(f) making an electrical connection between the fan assembly and to the wind turbine generator; and
(g) commanding the fan assembly on automatically when an electrical signal is received from the wind turbine generator.

2. The method for cooling airflow according to claim 1 further comprising the step of:
removing a cover of the cooler inlet before performing connecting step (a).

3. The method for cooling airflow according to claim 1 wherein connecting step (c) further comprises the steps of:
(c1) connecting a fan blades to a fan motor, wherein the fan assembly is comprised of the fan blades and the fan motor; and
(c2) connecting the fan motor to the shelf.

4. The method for cooling airflow according to claim 3 further comprising the steps of:
connecting a filter housing to the first fan shroud and to the second fan shroud;
inserting a prefilter into the filter housing; and
inserting a magnetic prefilter into the filter housing, wherein an air drawn by operation of the fan assembly travels first through the magnetic pre filter and then through the prefilter.

5. The method for cooling airflow according to claim 4 further comprising the step of:
using a hardware kit containing a plurality of hardware items for making all of the connections.

6. The method for cooling airflow according to claim 1 wherein making an electrical connection step (f) further comprises the steps of:
connecting a wire to the fan motor;
passing the wire through an opening of in the second fan shroud;
running the wire to a top of an electrical cabinet;
locating an unused breaker in the electrical cabinet and verifying that the unused breaker is wired to a terminal strip in the electrical cabinet;
installing a new contractor in the electrical cabinet;
locating and cutting a wires from the unused breaker and routing them into the new contractor;
connecting the wire to a terminal block in the electrical cabinet; and
connecting the new contractor in parallel with an existing gear box oil pumping high speed contactor signal wire.

7. A forced cooling apparatus comprising:
a first fan shroud;
a second fan shroud connected to the first fan shroud forming a circular structure;
a fan shroud adapter connected to a first end of the circular structure;
a filter housing connected to a second end of the circular structure;
a shelf connected to an inner portion of the second fan shroud;
a fan motor connected to the shelf;
a fan blades connected to the fan motor, wherein the fan motor and fan blades are contained within the circular structure;
a prefilter inserted first into the filter housing; and
a magnetic prefilter inserted next into the filter housing thereafter such that an air drawn by operation of the fan motor and the fan blades travels first through the magnetic pre filter and then through the prefilter.

8. The forced cooling apparatus according to claim 7 further comprising:
a hardware kit containing a plurality of hardware items for making all of the connections.

9. The forced cooling apparatus according to claim 7 wherein the shroud adapter 1 is configured to connect to a cooler inlet of a wind turbine generator.

10. The forced cooling apparatus according to claim 7 further comprising:
an opening in the second fan shroud for passing a wire therethrough, wherein the wire connects the fan motor to an electrical cabinet of the wind turbine generator.
